(19) United States
(12) Patent Application Publication
(10) Pub. No.: US 2002/0170538 A1
(43) Pub. Date: Nov. 21, 2002

(54) Lube control valve

(76) Inventor: Thomas B. Martin SR., El Dorado Hills, CA (US)

Correspondence Address: GLENN C. BROWN, PC, 777 NW WALL STREET, SUITE 308, BEND, OR, 97701, US

(21) Appl. No.: 10/121,551

(22) Filed: Apr. 12, 2002

Related U.S. Application Data
(60) Provisional application No. 60/283,578, filed on Apr. 12, 2001.

(51) Int. Cl. F02M 1/00

(52) U.S. Cl. 123/457

(57) ABSTRACT

A fuel injection system having a fuel flow regulating valve that directs a flow of pressurized fuel to a portion of pressurized fuel to an operable portion of a fuel pump. The flow regulating valve provides a predetermined flow responsive to a predetermined pressure or in another embodiment provides a variable flow rate responsive to variations in fuel pressure.

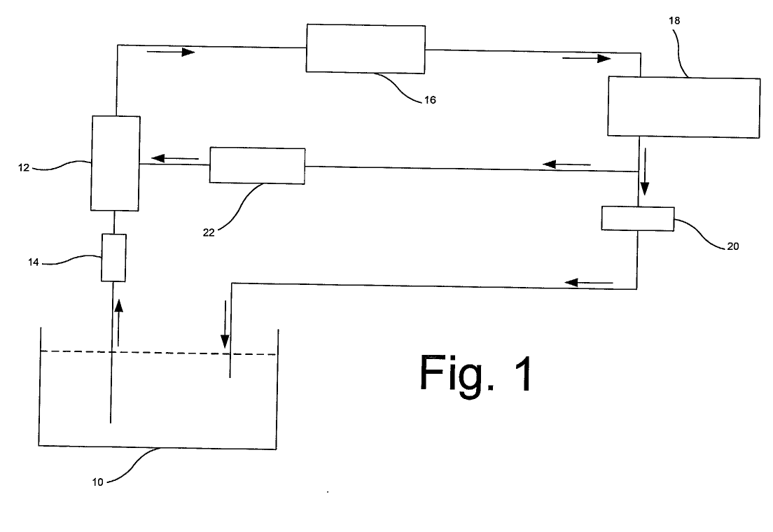

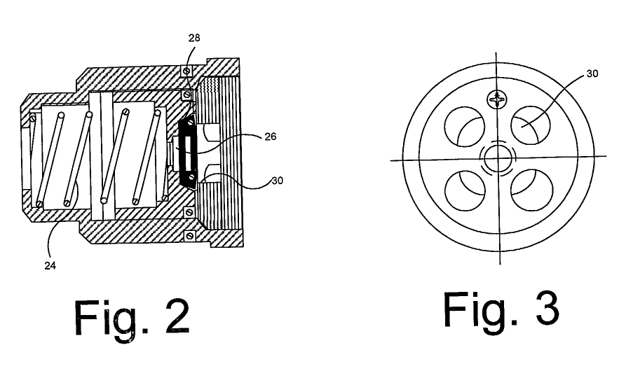

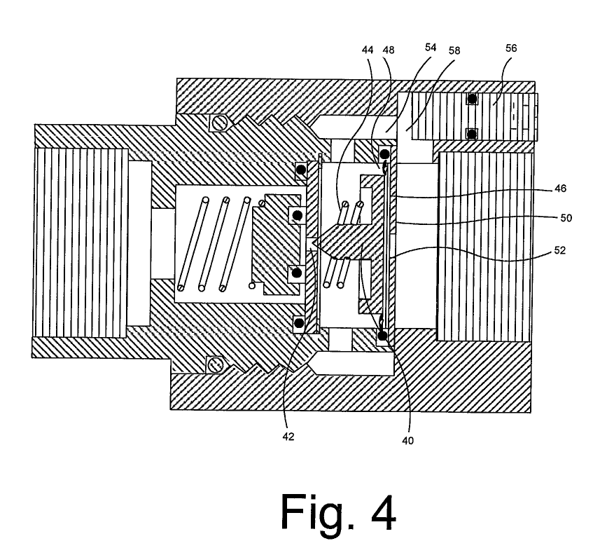

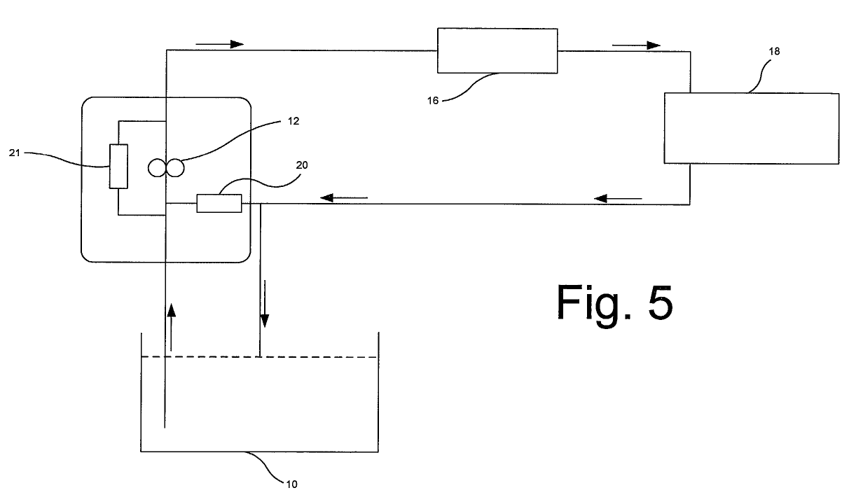

Various positive displacement pump assemblies are used to pump liquids that may contain particulate matter that is destructive to bearings, seals and other rubbing surfaces of the pumping unit. Particularly, pumps that supply fuel for diesel engines are likely to be required to handle “dirty” fuel of this nature which fuel is then filtered before being delivered to the engine's precision fuel injectors. It is not feasible to filter the fuel before entering the primary pump because the pressure drop through the filter will exceed the atmospheric suction head available to the pump. Suction strainers are used to keep out trash and other debris, but the fine particulates capable of damaging the pump assembly can easily pass through such strainers.

It is common industrial practice to supply lubrication and cooling fluids to sensitive areas in various kinds of equipment including pumps. Likewise, the present invention proposes to take a discrete amount of clean, filtered fuel oil from after the filter or from excess flow after the fuel injectors and return it to the pump assembly for the purpose of lubricating and cooling various moving parts thereof. However, for a diesel engine located in a vehicle having a fuel supply tank located below the engine and its accessory equipment, the pump is required to prime an occasionally “dry” system containing air. Such priming may require a suction lift in the order of six feet. To do this the pump suction must be substantially airtight. The slightest leakage of air into the suction side of the pump can cause priming to fail.

Therefore, an object of the present invention is to include a relief valve in the clean oil supply to the pump which requires a pressure differential greater than that required for suction lift before it will open to allow any fluid, including air, to enter the pump assembly.

Another object of the invention is to control the flow rate of the fuel being diverted to the pump assembly for lubrication and cooling purposes. Depending on how the fuel system back-pressure after the engine injectors is controlled, this pressure may be substantially constant if the fuel system back-pressure is controlled by a pressure regulating device, or it may vary considerably if controlled by the pressure drop through a fixed orifice, which is sensitive to variations in flow through the orifice. One source of flow variation which is always present is the amount of fuel burned by the engine, which is small at engine idling and increases to a maximum at full power. Another variation in flow is introduced if the fuel pump assembly is engine driven as opposed to being electric motor driven. The flow of the engine driven pump varies with engine rpm while the electric motor driven pump has substantially constant flow. All these variables can affect the fuel pressure that exists at the output end of the system. Therefore this object of the invention may be achieved either by providing a simple orifice as shown in Part No. 1040 if the pressure set by the pressure regulating device is substantially constant, or providing the flow regulating structure shown in Part No. 1041 if said pressure is subject to substantial variation.

A further object is to provide a control unit that is both cost-effective to produce, and highly reliable in its operation.

### REFERRING TO THE ENCLOSED DRAWINGS

Drawing No 1042 is a schematic drawing of a diesel engine fuel supply system. For various reasons such systems typically supply a fuel flow in excess of that required to power the engine.

Referring to the drawing, the system includes a fuel tank, a pump assembly, a suction strainer between the fuel tank and the pump assembly, a filter between the pump assembly and the diesel engine injection system. The excess flow that is not required to operate the engine continues on to a back-pressure regulating device, which is either a fixed orifice, or a pressure regulating mechanism designed to maintain the required fuel pressure for the engine injection system. From there the excess flow is directed back to the fuel tank. The present invention is incorporated in a valve assembly located in a line connected between the engine injection system and the pressure regulator for the purpose of diverting a portion of the excess fuel flow back to the pump. The valve assembly may also be included as part of the pump assembly itself, in which case the line would be connected directly to a port provided on the pump.

Part No. 1040 is a cross section of one embodiment of the invention in which the flow rate returning to the pump assembly is restricted by a fixed orifice as shown. Referring to the drawing, the spring exerts a force on the poppet to press the poppet seal, which is preferably an elastomeric seal into sealing relation with the orifice plate. The size of the orifice in the orifice plate may be used to control the rate of flow, or other restrictions in the line between the pressure regulator and the internal features of the pump assembly can serve the same purpose. The orifice plate is sealed to the valve body by the orifice plate elastomeric seal. The orifice plate retaining ring forces the orifice plate with its seal into sealing relation with the valve body. Therefore no flow can occur through the valve unless the spring force is exceeded to allow the poppet and its seal to move in order to open up the flow passage. In another embodiment of the invention the valve body may be a part of the pump assembly.

Part No. 1041 is a cross section of a further refinement of the invention that includes a flow-regulating feature in that the size of the orifice in the orifice plate is continuously controlled to maintain the diverted flow substantially constant during wide variations in pressure from the system. Referring to the drawing, a flow-metering needle is positioned to move toward and away from the orifice to change its effective size. The needle is forced away from the orifice by a second spring and against a flexible diaphram The flexible diaphram is sealed against the valve body by means of a diaphram seal and a pressure plate that has a small hole to allow upstream pressure to act against the diaphram to oppose the force of the second spring. Since no flow can get past the diaphram, a flow passage is provided around the diaphram, which is restricted by the flow-metering adjustment screw to form a flow-metering orifice. When flow occurs, the pressure drop through the flow-metering orifice causes a pressure difference across the diaphram that opposes the force of the second spring. When the flow increases to the point where the metering pressure-drop exceeds the force of the second spring the flow-metering needle moves toward the orifice plate to restrict the orifice and prevent further increase in flow. In operation the flow stabilizes around the flow required to move the needle against the force of the second spring regardless of the pressure in the system. The pressure-drop across the flexible diaphram never exceeds that required to compress the second spring. Therefore the diaphram is never subjected to high differential pressure and can be made quite flexible.

I claim:

1. An internal combustion fuel system comprising: a fuel tank;
an engine fuel injection system;
a fuel pump having an inlet in communication with the fuel tank, an outlet in communication with the engine fuel injection system, and a lubricated operable portion;
a pressure regulator in communication with the fuel pump outlet;
a flow regulating valve having an inlet in communication with the engine fuel injection system and the pressure regulator and having an outlet in communication with the fuel pump lubricated operable portion; and,
the flow regulating valve operable to direct a flow of pressurized fuel from the fuel pump outlet to the fuel pump operable portion responsive to a predetermined pressure in the fuel outlet.
